(19) United States
(12) Patent Application Publication
(10) Pub. No.: US 2024/0264931 A1
(43) Pub. Date: Aug. 8, 2024

(54) STORAGE OPTIMIZATION METHOD AND APPARATUS FOR DISTRIBUTED STORAGE SYSTEM

(71) Applicant: SUZHOU METABRAIN INTELLIGENT TECHNOLOGY CO., LTD., Suzhou, Jiangsu (CN)

(72) Inventor: Xusheng ZHANG, Suzhou, Jiangsu (CN)

(21) Appl. No.: 18/696,388

(22) PCT Filed: Sep. 30, 2022
(86) PCT No.: PCT/CN2022/123405

§ 371 Date: Mar. 28, 2024

(30) Foreign Application Priority Data
Jan. 28, 2022 (CN) 202210105269.0

(51) Int. Cl. G06F 12/02

(52) U.S. Cl. CPC G06F 12/023

(57) ABSTRACT

The disclosure provides a storage optimization method and apparatus for a distributed storage system. The method includes: acquiring a data capacity of new bluefs log metadata when new bluefs log metadata are monitered; allocating a first space based on the data capacity; storing the new bluefs log metadata to the first space; and updating the storage information of the first space to a boot area of the bluestore to perform log replay based on the storage information of the boot area of the bluestore. Thus, by means of the phase-change extension of the bluestore boot area, the size of bluefs log metadata is extended to completely eliminate the restriction of a minimum size of bluestore allocated space, which improves the stability of the distributed storage system in a small block read-write scene and the competitiveness of the distributed storage system. Thus, the distributed storage system can be applied to more input and output scenes.

### CROSS-REFERENCE TO RELATED APPLICATIONS

The disclosure claims priority to Chinese Patent Application No. 202210105269.0, entitled “storage optimization method and apparatus for distributed storage system”, filed to China Patent Office on Jan. 28, 2022, the entire contents of which are incorporated herein by reference.

### TECHNICAL FIELD

The disclosure relates to the technical field of distributed storage, and particularly relates to a storage optimization method and apparatus for a distributed storage system.

### BACKGROUND

In a distributed storage system, an object storage device (OSD) provides the basic service of hard disk management, and is responsible for reading and writing data on the hard disk. Therefore, the stability of OSD service plays an important role in the whole distributed storage system. In the OSD service, the bluefs file system is responsible for completing the file read-write function of the upper-level database on the storage medium. However, in the current distributed storage system, when the minimum allocation space of the bluestore is set too small, the available space of the bluestore will become very trivial after a long time of small block reading and writing. When the bluefs log uses this space, it is easy to cause the log metadata volume of the bluefs to be very large, thereby exceeding the size of the bluestore boot area and causing the OSD service to stop working.

### SUMMARY

In view of this, the embodiments of the disclosure provide a storage optimization method and apparatus for a distributed storage system, so as to overcome the limitation of the bluefs in the conventional technology being limited by the minimum allocation visible size of the bluestore, making the distributed storage system unstable in a small block read-write scenario, and easily causing the OSD service to stop working.

According to a first aspect, embodiments of the present application discloses a storage optimization method for a distributed storage system, comprising:
acquiring a data capacity of the new bluefs log metadata when new bluefs log metadata are monitered;
allocating a first space based on the data capacity;
storing the new bluefs log metadata to the first space; and
updating the storage information of the first space to a boot area of the bluestore to perform log replay based on the storage information of the boot area of the bluestore.

According to some embodiments, allocating a first space based on the data capacity comprises:
based on the data capacity, applying a storage space matched with the data capacity to an allocator, and using the storage space matched with the data capacity as the first space.

According to some embodiments, the method further comprising:
acquiring a second space corresponding to current bluefs log metadata; and
releasing the second space.

According to some embodiments, the releasing the second space comprises:
releasing the second space when it is determined that the second space satisfies a corresponding release condition.

According to some embodiments, the releasing the second space when it is determined that the second space satisfies a corresponding release condition condition comprises:
putting the second space into a queue to be released; and
releasing the second space when the second space in the queue to be released satisfies the corresponding release condition.

According to some embodiments, the releasing the second space when the second space in the queue to be released satisfies the corresponding release condition comprises:
timing when the second space is put into the queue to be released, and releasing the second space when a pre-set time is reached.

According to some embodiments, the releasing the second space when the second space in the queue to be released satisfies the corresponding release condition comprises:
releasing the second space after updating the storage information of the first space to the boot area of the bluestore.

According to some embodiments, the updating storage information of the first space to the boot area of the bluestore comprises:
storing the storage information of the first space to a superblock of the boot area of the bluestore.

According to some embodiments, the storing the storage information of the first space to a superblock of the boot area of the bluestore comprises:
encoding the storage information of the first space according to a predetermined encoding mode to obtain first data; and
storing the first data to the superblock of the boot area of the bluestore.

According to some embodiments, the performing log replay based on the storage information of the boot area of the bluestore comprises:
extracting current storage information from the boot area of the bluestore, and acquiring association information between bluefs log metadata and a storage space based on the current storage information; and
searching for an actual storage space for storing the bluefs log metadata based on the association information between the bluefs log metadata and the storage space, so as to read a log from the actual storage space for log replay.

According to some embodiments, the searching for an actual storage space for storing the bluefs log metadata based on the association information between the bluefs log metadata and the storage space, so as to read a log from the actual storage space for log replay comprises:
determining a third space for currently storing the bluefs log metadata based on the association information between the bluefs log metadata and the storage space; and
extracting the bluefs log metadata from the third space for log replay.

According to some embodiments, the extracting current storage information from the boot area of the bluestore comprises:
reading first data stored in the superblock of the boot area of the bluestore; and
decoding the first data to obtain current storage information.

According to some embodiments, the determining a third space for currently storing the bluefs log metadata based on the association information between the bluefs log metadata and the storage space comprises:
determining a storage space corresponding to a first node based on the association information between the bluefs log metadata and the storage space;
decoding second data stored in the storage space to obtain first node information; and
determining a third space for currently storing the bluefs log metadata based on the first node information.

According to some embodiments, the method further comprises:
traversing the bluefs to build new bluefs log metadata.

According to some embodiments, the traversing the bluefs comprises:
traversing the bluefs in a fixed period of time.

According to some embodiments, the traversing the bluefs comprises:
traversing the bluefs in response to a need to update the bluefs log metadata.

According to a second aspect, embodiments of the present application discloses a storage optimization apparatus for a distributed storage system, comprising:
a first acquisition module configured for acquiring a data capacity of the new bluefs log metadata when new bluefs log metadata are monitered;
a first processing module configured for allocating a first space based on the data capacity;
a second processing module configured for storing the new bluefs log metadata to the first space; and
a third processing module configured for updating the storage information of the first space to a boot area of the bluestore to perform log replay based on the storage information of the boot area of the bluestore.

According to some embodiments, the first processing module is further configured for, based on the data capacity, applying a storage space matched with the data capacity to an allocator, and using the storage space matched with the data capacity as the first space.

According to a first aspect, embodiments of the present application discloses an electronic device, comprising:
a memory and a processor communicatively coupled to each other, wherein the memory has computer instructions stored therein; and the processor executes the computer instructions to perform the method according to the first aspect and the embodiments of the present application.

According to a first aspect, embodiments of the present application discloses a computer non-volatile readable storage medium, wherein the computer non-volatile readable storage medium stores computer instructions which when executed by a processor implement the method according to the first aspect and the embodiments of the present application.

The technical solution of the disclosure has the following advantages.

The embodiments of the disclosure provide a storage optimization method and apparatus for a distributed storage system, including: acquiring a data capacity of new bluefs log metadata when new bluefs log metadata are monitered; allocating a first space based on the data capacity; storing the new bluefs log metadata to the first space; and updating the storage information of the first space to a boot area of the bluestore to perform log replay based on the storage information of the boot area of the bluestore Thus, the bluefs log metadata is stored by allocating a new space, and the storage information of the new space is used as index data to be stored in an original space of the bluestore boot area so as to realize the guiding of the bluefs log metadata. A space for actually storing the bluefs log metadata is found by using the storage information of the original space of the bluestore boot area so as to realize the log replay, thereby completely freeing the bluefs from the limitation of the minimum size of bluestore allocated space. The stability of the distributed storage system in a small block read-write scene is improved, and the competitiveness of the distributed storage system is further improved. This kind of phase-change extension of the bluestore boot area achieves the extension of the size of bluefs log metadata, so that the distributed storage system can be applied to more input and output scenes.

### BRIEF DESCRIPTION OF THE DRAWINGS

In order to more clearly describe the technical solutions in the embodiments of the disclosure or the conventional technology, the drawings to be used in the description of the embodiments or the conventional technology will be briefly introduced below. It will be apparent to those skilled in the art that the drawings in the following description are some of the disclosure, and that other drawings may be obtained from the drawings without any creative works.

FIG. 1 is a flow diagram of a storage optimization method for a distributed storage system in an embodiment of the disclosure;

FIG. 2 is a schematic diagram of a bluefs log metadata compression process in an embodiment of the disclosure;

FIG. 3 is a schematic diagram of a bluefs log replay process in an embodiment of the disclosure;

FIG. 4 is a schematic structural diagram of a storage optimization apparatus for the distributed storage system in an embodiment of the disclosure; and

FIG. 5 is a schematic structural diagram of an electronic device in an embodiment of the disclosure.

### DETAILED DESCRIPTION OF THE EMBODIMENTS

In order to make the objectives, technical solutions, and advantages of the embodiments of the disclosure clearer, the technical solutions in the embodiments of the disclosure will be described clearly and completely in conjunction with the accompanying drawings in the embodiments of the disclosure. Obviously, the described embodiments are part of the embodiments of the disclosure, rather than all of the embodiments. Based on the embodiments in the disclosure, all other embodiments obtained by a person skilled in the art without involving any inventive effort are within the scope of protection of the disclosure.

In the description of the disclosure, it should be understood that the directional or positional relationships indicated by the terms “center”, “up”, “down”, “front”, “left”, “right”, “vertical”, “horizontal”, “inner”, “outer” and the like are based on the directional or positional relationships shown in the drawings. It is merely for the purpose of describing the disclosure and simplifying the description, and is not intended to indicate or imply that a particular orientation, configuration and operation of the referenced apparatus or element is required and should not be construed as limiting the scope of the present application. Furthermore, the terms “first”, “second”, “third”, and the like are used solely for descriptive purposes and are not to be construed as indicating or implying relative importance.

In the description of the disclosure, it should be understood that the terms “mounted”, “connected”, or “connecting” are to be broadly construed as being, for example, fixed connection, removable connection, or integrate connection, unless specifically stated and defined otherwise. They may be mechanical connection or electrical connection. Also, they may be direct or indirect connection through an intermediary, may be communication internal to two elements and may be wireless connection or wired connection. The specific meaning of the above terms in the disclosure will be understood in specific circumstances by those of ordinary skill in the art.

The technical features involved in the various embodiments of the disclosure described below may be combined with each other as long as they do not conflict with each other.

Firstly, the relevant terms used in the embodiments of the disclosure are described.

Bluestore: the manner in which the distributed storage system manages the underlying storage medium.

OSD: the data storage basic service of the distributed storage system, which is responsible for reading and writing data on a hard disk.

Bluefs: a layer of file system above bluestore, which is used to complete the reading and writing operations of upper database, similar to the xfs file system of the linux operating system.

In the distributed storage system, OSD, as the basic service of hard disk management, is responsible for reading and writing data on the hard disk. Therefore, the stability of OSD service plays an important role in the whole distributed storage system. In the OSD service, the bluefs file system is responsible for completing the file read-write function of the upper-level database on the storage medium. However, in the current distributed storage system, when the minimum allocation space of the bluestore is set too small, the available space of the bluestore will become very trivial after a long time of small block reading and writing. When the bluefs log uses this space, it is easy to cause the log metadata volume of the bluefs to be very large, thereby exceeding the size of the bluestore boot area and causing the OSD service to stop working.

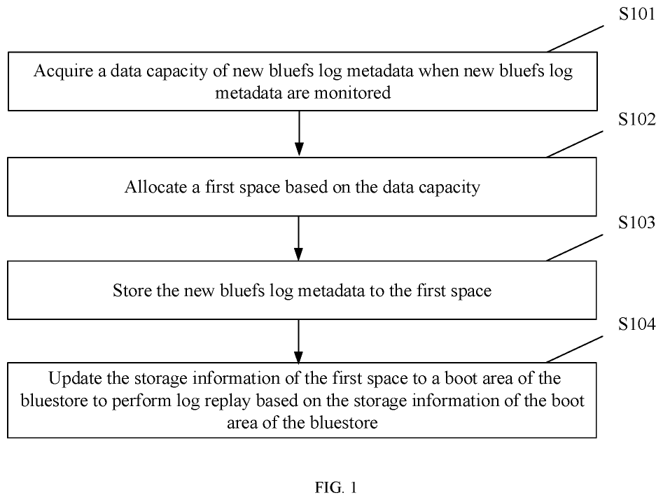

Based on the above-mentioned problems, an embodiment of the disclosure provides a storage optimization method for a distributed storage system. As shown in FIG. 1, the storage optimization method for the distributed storage system includes the following steps.

Step S101: a data capacity of new bluefs log metadata is acquired when new bluefs log metadata are monitered.

The data capacity is the size of new bluefs log metadata.

Step S102: a first space is allocated based on the data capacity.

A storage space matching its data size is applied to the allocator according to the size of the bluefs log metadata.

Step S103: the new bluefs log metadata is stored to the first space.

By storing the new bluefs log metadata to the storage space allocated by a new application, there is no need to occupy the original space of the bluestore boot area, thereby freeing the bluestore from the limitation of the minimum size of the bluestore allocated space.

Step S104: the storage information of the first space is updated to a boot area of the bluestore to perform log replay based on the storage information of the boot area of the bluestore.

The storage information of the first space is stored into a superblock of the boot area of the bluestore.

The storage information is association information between the new bluefs log metadata and the storage space. It is convenient for subsequently finding a storage space for actually storing the bluefs log metadata based on the storage information so as to read the log log from the corresponding space for log replay.

By executing the above-mentioned steps, according to the storage optimization method for the distributed storage system in an embodiment of the disclosure. The bluefs log metadata is stored by allocating a new space, and the storage information of the new space is used as index data to be stored in an original space of the bluestore boot area so as to realize the guiding of the bluefs log metadata. A space for actually storing the bluefs log metadata is found by using the storage information of the original space of the bluestore boot area so as to realize the log replay, thereby completely freeing the bluefs from the limitation of the minimum size of bluestore allocated space. The stability of the distributed storage system in a small block read-write scene is improved, and the competitiveness of the distributed storage system is further improved. This kind of phase-change extension of the bluestore boot area achieves the extension of the size of bluefs log metadata, so that the distributed storage system can be applied to more input and output scenes.

In an embodiment, the above-mentioned step S104 of performing log replay based on the storage information of the boot area of the bluestore includes the following steps.

Step (1): the current storage information is extracted from the boot area of the bluestore. It can be seen from the above-mentioned contents that the storage information of the first space is the association information between the new bluefs log metadata and the storage space. Thus, the current storage information records the association information between the current bluefs log metadata and the storage space. The association information between the bluefs log metadata and the storage space may be acquired according to the current storage information. Based on the association information between the bluefs log metadata and the storage space, the actual storage space for storing the bluefs log metadata can be found, so as to read the log from the actual storage space for log replay.

The above-mentioned Step (1) is performed by reading first data stored in the superblock of the boot area of the bluestore; and decoding the first data to obtain the current storage information. In practical applications, when storage information is added to the superblock of the boot area of the bluestore, the storage information is encoded according to a predetermined encoding mode to obtain the above-mentioned first data for storage, so as to reduce storage space and improve the space utilization rate of the boot area of the bluestore. Accordingly, the corresponding storage information may be obtained by decoding the data stored in the superblock.

Step (2): a third space for currently storing the bluefs log metadata is determined based on the current storage information.

The above-mentioned step (2) determines a storage space corresponding to a first node based on the current storage information, namely, by means of association information between the bluefs log metadata and the storage space. Second data stored in the storage space is decoded to obtain information of the first node. The third space for currently storing the bluefs log metadata is determined based on the information of the first node. In practical applications, since the spatial location information for storing the bluefs log metadata is stored in the first node fnode, the information of the first node can be extracted by determining the storage space of the first node, and then the storage location for storing the bluefs log metadata can be determined by comparing the information of the first node.

Step (3): the bluefs log metadata is extracted from the third space for log replay.

After the actual storage location of the bluefs log metadata is determined, the log can be read from the corresponding actual storage location for log replayed. For the specific replay process, reference can be made to the relevant description of log replay in the conventional technology, and the description thereof will not be repeated here.

In an embodiment, the above-mentioned storage optimization method for the distributed storage system further includes the following steps.

Step (1) a second space corresponding to current bluefs log metadata is acquired; and step (2) the second space is released.

Among them, the second space is an actual storage location of the current bluefs log metadata before the new bluefs log metadata is generated. Upon releasing the second space, the second space may be released upon determining that the second space satisfies the corresponding release condition.

In other embodiments, the above-described storage optimization method of the distributed storage system may further put the second space into a queue to be released. When the second space in the queue to be released satisfies a corresponding release condition, the second space is released.

Herein, when the space stored in the queue to be released satisfies the corresponding release condition, the release condition may be automatically releasing at a fixed time such as after adding a certain time in the queue to be released, or other release conditions are satisfied. The disclosure is not limited thereto. For example, it starts counting when the second space is put in the queue to be released. The second space is released when a pre-set time is reached, or the second space may be released after the storage information of the first space is updated to the boot area of the bluestore.

In the embodiments of the disclosure, the above-mentioned release condition is that after the storage space information of the new bluefs log metadata is updated to the boot area of the bluestore, the original storage space is released, thereby further improving the utilization rate of the storage space of the boot area of the bluestore, and at the same time ensuring a one-to-one corresponding relationship between the bluefs log metadata and the storage space, and thus ensuring the accuracy of the bluestore boot result.

In an embodiment, before the above-mentioned step S101 is executed, the above-mentioned storage optimization method for the distributed storage system further includes the following steps.

The bluefs is traversed to build new bluefs log metadata.

In practical applications, the bluefs may be traversed in a fixed period of time, and new bluefs log metadata is built according to the structure of each traversal. Also, when the bluefs log metadata needs to be updated, the bluefs may be traversed, namely, in response to the need of updating the bluefs log metadata. The bluefs is traversed and the new bluefs log metadata is built, and the disclosure is not limited thereto. With regard to the implementation process of traversing the bluefs to build new bluefs log metadata is conventional technology, and reference can be made to the implementation mode of the conventional technology for details. The description thereof will not be repeated here.

The operation of the storage optimization method for the distributed storage system provided by the embodiments of the disclosure will be described in detail with reference to application examples.

The embodiment of the disclosure mainly implements an extension to a bluestore boot area in a distributed storage system. The bluefs log metadata is stored via an extended space, while an original space is used for storing information of the extended space. In this way, regardless of the metadata information of the bluefs log, we only need to apply for a space of a corresponding size for storage and write the applied space into the boot area of the bluestore to complete the boot of the bluefs log metadata. In the implementation process, it is mainly divided into the following two parts.

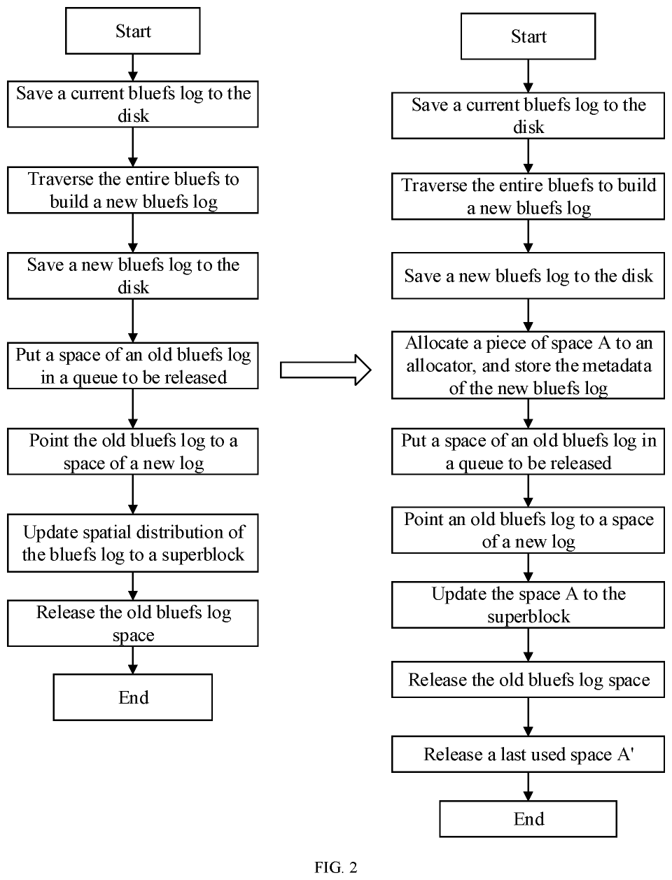

1. In a distributed storage system creation or bluefs log compression process, an exemplary bluefs log compression process implementation is shown in FIG. 2.

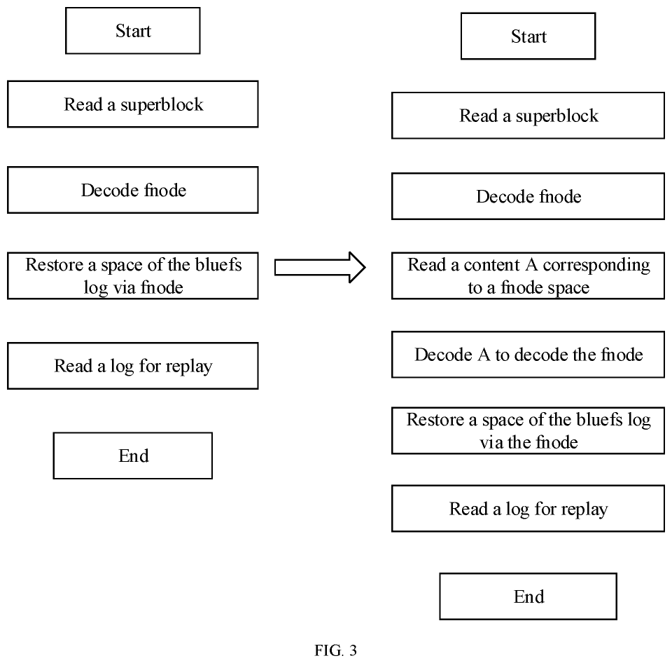

2. In the bluefs file system recovery process after the OSD service is started, an exemplary implementation of the bluefs log replay process is shown in FIG. 3.

The disclosure extends the number of bluefs log metadata and increases the stability of a OSD service by applying for a new space for storing the bluefs log metadata instead of using the original space pf the superblock of bluestore. By the phase-change extension of bluestore boot area, the size of bluefs log metadata is extended, which not only makes OSD service improve stability, but also makes the storage system applicable to more IO scenarios.

By executing the above-mentioned steps, according to the storage optimization method for the distributed storage system in an embodiment of the disclosure. The bluefs log metadata is stored by allocating a new space, and the storage information of the new space is used as index data to be stored in an original space of the bluestore boot area so as to realize the guiding of the bluefs log metadata. A space for actually storing the bluefs log metadata is found by using the storage information of the original space of the bluestore boot area so as to realize the log replay, thereby completely freeing the bluefs from the limitation of the minimum size of bluestore allocated space. The stability of the distributed storage system in a small block read-write scene is improved, and the competitiveness of the distributed storage system is further improved. This kind of phase-change extension of the bluestore boot area achieves the extension of the size of bluefs log metadata, so that the distributed storage system can be applied to more input and output scenes.

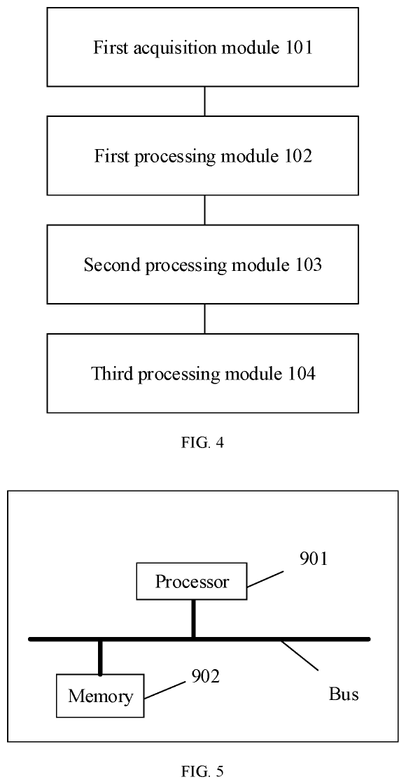

The embodiment of the disclosure also provides a storage optimization apparatus for a distributed storage system. As shown in FIG. 4, the storage optimization apparatus for the distributed storage system includes a first acquisition module 101, a second processing module 103 and a third processing module 104.

The first acquisition module 101 is configured for acquiring a data capacity of new bluefs log metadata when new bluefs log metadata are monitered. For details, reference is made to the detailed description of Step S101 described above, and the detailed description thereof will not be repeated here.

The first processing module 102 is configured for allocating a first space based on the data capacity. For details, reference is made to the detailed description of step S102 described above, and the detailed description thereof will not be repeated here.

The second processing module 103 is configured for storing the new bluefs log metadata to the first space. For details, reference is made to the detailed description of Step S103 described above, and the detailed description thereof will not be repeated here.

The third processing module 104 is configured for updating the storage information of the first space to a boot area of the bluestore to perform log replay based on the storage information of the boot area of the bluestore. For details, reference is made to the detailed description of Step S104 described above, and the detailed description thereof will not be repeated here.

By the cooperation of the above-mentioned various components, according to the storage optimization device for the distributed storage system provided in an embodiment of the disclosure, the bluefs log metadata is stored by allocating a new space, and the storage information of the new space is used as index data to be stored in an original space of the bluestore boot area so as to realize the guiding of the bluefs log metadata. A space for actually storing the bluefs log metadata is found by using the storage information of the original space of the bluestore boot area so as to realize the log replay, thereby completely freeing the bluefs from the limitation of the minimum size of bluestore allocated space. The stability of the distributed storage system in a small block read-write scene is improved, and the competitiveness of the distributed storage system is further improved. This kind of phase-change extension of the bluestore boot area achieves the extension of the size of bluefs log metadata, so that the distributed storage system can be applied to more input and output scenes.

In an embodiment, the first processing module is further configured for, based on the data capacity, applying a storage space matched with the data capacity to an allocator, and using the storage space matched with the data capacity as the first space.

In an embodiment, the storage optimization apparatus for the distributed storage system described above further includes:
a second acquisition module configured for acquiring a second space corresponding to current bluefs log metadata; and a release module configured for releasing the second space.

In an embodiment, the release module is further configured for releasing the second space when it is determined that the second space satisfies the corresponding release condition.

In an embodiment, the release module includes:
a fourth processing module configured for putting the second space into the queue to be released; and
a fifth processing module configured for releasing the second space when the second space in the queue to be released satisfies a corresponding release condition.

In an embodiment, the fifth processing module is further configured for timing when the second space is put in the queue to be released, and for releasing the second space when a pre-set time is reached.

In an embodiment, the fifth processing module is further configured for releasing the second space after updating the storage information of the first space to the boot area of the bluestore.

In particular, in an embodiment, the third processing module is configured for storing the storage information of the first space into a superblock of the boot area of the bluestore.

In an embodiment, the third processing module is further configured for encoding the storage information of the first space according to a predetermined encoding mode to obtain the first data. The first data is stored in the superblock of the boot area of the bluestore.

In an embodiment, the third processing module 104 described above includes:
an extraction unit configured for extracting current storage information from the boot area of the bluestore, and acquiring association information between the bluefs log metadata and the storage space based on the current storage information; and
a searching unit configured for finding an actual storage space for storing the bluefs log metadata based on the association information between the bluefs log metadata and the storage space, so as to read the log from the actual storage space for log replay.

According to some embodiments, the lookup unit includes:
a processing unit configured for determining a third space for currently storing the bluefs log metadata based on the association information between the bluefs log metadata and the storage space; and
a replay unit configured for extracting the bluefs log metadata from the third space for log replay.

In particular, in an embodiment, the extraction unit described above is used for reading first data stored in the superblock of the boot area of the bluestore; and decoding the first data to obtain the current storage information.

In an embodiment, the above-mentioned processing unit is used for determining a storage space corresponding to a first node based on the association information between the bluefs log metadata and the storage space. Second data stored in the storage space is decoded to obtain information of the first node. The third space for currently storing the bluefs log metadata is determined based on the information of the first node.

In an embodiment, the storage optimization apparatus for the distributed storage system described above further includes:
a sixth processing module configured for traversing the bluefs to build new bluefs log metadata.

According to some embodiments, the sixth processing module is further configured for traversing the bluefs in a fixed period of time.

According to some embodiments, the sixth processing module is further configured for traversing the bluefs in response to a need to update the bluefs log metadata.

By the cooperation of the above-mentioned various components, according to the storage optimization apparatus for the distributed storage system provided in an embodiment of the disclosure, the bluefs log metadata is stored by allocating a new space, and the storage information of the new space is used as index data to be stored in an original space of the bluestore boot area so as to realize the guiding of the bluefs log metadata. A space for actually storing the bluefs log metadata is found by using the storage information of the original space of the bluestore boot area so as to realize the log replay, thereby completely freeing the bluefs from the limitation of the minimum size of bluestore allocated space. The stability of the distributed storage system in a small block read-write scene is improved, and the competitiveness of the distributed storage system is further improved. This kind of phase-change extension of the bluestore boot area achieves the extension of the size of bluefs log metadata, so that the distributed storage system can be applied to more input and output scenes.

As shown in FIG. 5, the disclosure embodiment also provides an electronic device that may include a processor 901 and a memory 902, where the processor 901 and the memory 902 may be connected by a bus or other means, as shown in FIG. 5, by a bus connection.

The processor 901 may be a central processing unit (CPU). The processor 901 may be other general purpose processor, a digital signal processor (DSP), an application specific integrated circuit (ASIC), a field-programmable gate array (FPGA) or chips such as other programmable logic device, a discrete gate or transistor logic device, a discrete hardware component, or a combination of the above types of chips.

The memory 902, as a non-transient computer non-volatile readable storage medium, may be used to store non-transient software programs, non-transient computer executable programs, and modules, such as program instructions/modules corresponding to the method in the embodiments of the disclosure. The processor 901 implements the above method by running non-transient software programs, instructions, and modules stored in the memory 902 to perform various functional applications of the processor and data processing.

The memory 902 may include a stored program area and a stored data area, where the stored program area may store an operating device, and an application program required for at least one function. The storage data area may store data created by the processor 901. In addition, the memory 902 may include a high-speed random access memory and may also include a non-transient memory, such as at least one disk storage device, a flash memory device, or other non-transient solid-state storage devices. In some embodiments, the memory 902 may includes a memory remotely located with respect to the processor 901, which may be connected to the processor 901 via a network. Examples of such networks include, but are not limited to, the Internet, intranets, local area networks, mobile communication networks, and combinations thereof.

One or more modules are stored in the memory 902 that, when executed by the processor 901, perform the methods described above.

The details of the above-described server can be understood with reference to the corresponding description and effects of the above-described method embodiments, and will not be described in detail herein.

A person skilled in the art may understand that the realization of all or part of the process in the above embodiments method may be accomplished by instructing the relevant hardware by a computer program, that the realized program may be stored in a computer readable storage medium, and that the program, when executed, may include a process such as that of the embodiments of the above methods. The storage medium can be a magnetic disk, an optical disk, a read-only memory memory (ROM), a random access memory (RAM), a flash memory and a hard disk drive (HDD) or a solid-state drive (SSD) etc. The storage medium may also include a combination of memories of the kind described above.

Although embodiments of the disclosure have been described with reference to the accompanying drawings, various modifications and changes may be made by those skilled in the art without departing from the spirit and scope of the disclosure, and it is intended that such modifications and changes come within the scope of the appended claims.

1. A storage optimization method for a distributed storage system, comprising:
acquiring a data capacity of the new bluefs log metadata in response to that new bluefs log metadata are monitered;
allocating a first space based on the data capacity;
storing the new bluefs log metadata to the first space; and
updating the storage information of the first space to a boot area of the bluestore to perform log replay based on the storage information of the boot area of the bluestore.

2. The method according to claim 1, wherein the allocating a first space based on the data capacity comprises:
based on the data capacity, applying a storage space matched with the data capacity to an allocator, and using the storage space matched with the data capacity as the first space.

3. The method according to claim 1, further comprising:
acquiring a second space corresponding to current bluefs log metadata; and
releasing the second space.

4. The method according to claim 3, wherein the releasing the second space comprises:
releasing the second space in response to determining the second space satisfies a corresponding release condition.

5. The method according to claim 4, wherein the releasing the second space in response to determining the second space satisfies a corresponding release condition condition comprises:
putting the second space into a queue to be released; and
releasing the second space in response to that the second space in the queue to be released satisfies the corresponding release condition.

6. The method according to claim 5, wherein the releasing the second space in response to that the second space in the queue to be released satisfies the corresponding release condition comprises:
timing when the second space is put into the queue to be released, and releasing the second space when a pre-set time is reached.

7. The method according to claim 5, wherein the releasing the second space in response to that the second space in the queue to be released satisfies the corresponding release condition comprises:
releasing the second space after updating the storage information of the first space to the boot area of the bluestore.

8. The method according to claim 1, wherein the updating storage information of the first space to the boot area of the bluestore comprises:
storing the storage information of the first space to a superblock of the boot area of the bluestore.

9. The method according to claim 1, wherein the storing the storage information of the first space to a superblock of the boot area of the bluestore comprises:
encoding the storage information of the first space according to a predetermined encoding mode to obtain first data; and
storing the first data to the superblock of the boot area of the bluestore.

10. The method according to claim 1, wherein the performing log replay based on the storage information of the boot area of the bluestore comprises:
extracting current storage information from the boot area of the bluestore, and acquiring association information between bluefs log metadata and a storage space based on the current storage information; and
searching for an actual storage space for storing the bluefs log metadata based on the association information between the bluefs log metadata and the storage space, so as to read a log from the actual storage space for log replay.

11. The method according to claim 10, wherein the searching for an actual storage space for storing the bluefs log metadata based on the association information between the bluefs log metadata and the storage space, so as to read a log from the actual storage space for log replay comprises:
determining a third space for currently storing the bluefs log metadata based on the association information between the bluefs log metadata and the storage space; and
extracting the bluefs log metadata from the third space for log replay.

12. The method according to claim 11, wherein the extracting current storage information from the boot area of the bluestore comprises:
reading first data stored in the superblock of the boot area of the bluestore; and
decoding the first data to obtain current storage information.

13. The method according to claim 11, wherein the determining a third space for currently storing the bluefs log metadata based on the association information between the bluefs log metadata and the storage space comprises:
determining a storage space corresponding to a first node based on the association information between the bluefs log metadata and the storage space;
decoding second data stored in the storage space to obtain first node information; and
determining a third space for currently storing the bluefs log metadata based on the first node information.

14. The method according to claim 1, further comprising:
traversing the bluefs to build new bluefs log metadata.

15. The method according to claim 14, wherein the traversing the bluefs comprises:
traversing the bluefs in a fixed period of time.

16. The method according to claim 14, wherein the traversing the bluefs comprises:
traversing the bluefs in response to a need to update the bluefs log metadata.

17. (canceled)

18. (canceled)

19. An electronic device, comprising:
a memory and a processor communicatively coupled to each other, wherein the memory has computer instructions stored therein; and the processor executes the computer instructions to perform the method according to claim 1.

20. A computer non-volatile readable storage medium, wherein the computer non-volatile readable storage medium stores computer instructions which when executed by a processor implement the method according to claim 1.

21. The electronic device according to claim 19, wherein the allocating a first space based on the data capacity comprises:
based on the data capacity, applying a storage space matched with the data capacity to an allocator, and using the storage space matched with the data capacity as the first space.

22. The electronic device according to claim 19, wherein the operations further comprise:
acquiring a second space corresponding to current bluefs log metadata; and
releasing the second space.
